(19) United States
(12) Patent Application Publication
(10) Pub. No.: US 2005/0263936 A1
(43) Pub. Date: Dec. 1, 2005

(54) Device for producing film webs from a film tube by cutting open the squeezed air buble

(76) Inventor: Frank Bosse, Tecklenburg (DE)

Correspondence Address: JACOBSON HOLMAN PLLC, 400 SEVENTH STREET N.W., SUITE 600, WASHINGTON, DC, 20004, US

(21) Appl. No.: 10/524,500

(22) PCT Filed: Sep. 19, 2003
(86) PCT No.: PCT/EP03/10504

§ 371 Date: Feb. 14, 2005

(30) Foreign Application Priority Data
Sep. 30, 2002 (DE) 102 43 959.1

(51) Int. Cl. B28B 11/16

(52) U.S. Cl. 264/146; 425/308

(57) ABSTRACT

Shown is a device and a method for production of film tracks (7, 17) from a film tube (1). Devices according to the current status of technology contain
a lay-flat device (2), which consists preferably out of two lay-flat plates (12, 22) arrange in a mutual roof-like formation, whose distance decreases in the direction of the conveyance (z) of the tube.
a squeeze roller device (3), which consists preferably of a squeeze roller pair (13, 23),
and at least one cutting device (4, 5), which slits the film tube along its direction of conveyance. The device according to the invention contains additionally:
at least one pre-squeeze device (6), which is provided in the direction of conveyance of the film tube (z) before the squeeze roller device (3),
and which leaves a residual amount of air in the film tube, so that in the region between the squeeze roller device (3) and at least one pre-squeeze roller device (6) a static air cushion forms.

Thereby, the film tube (1) can be scratched in the region of the static air cushion (9) by means of the cutting device (4, 5).

The invention relates to a device and a process for producing film tracks from a tubular film
with a lay-flat device, which preferably consists of two lay-flat plates arranged roof-like against each other,
and a squeeze device, which preferably consists of squeeze roller pair and which compresses the film and
is provided with at least one cutting device, which slits the film tube along its direction of conveyance.

Devices of this type are in general used together with tubular film extrusion systems. Often, a film tube is extruded, laid flat, squeezed and subsequently conveyed to a winding device. Particularly worthy of mention is that, as a rule, the tubular film track passes through a reversing device after the squeezing.

All the abovementioned function units are known in the printed literature. For example, DE 100 40 055 claims such a reversing device and also shows the related squeezing and lay-flat devices.

In order to transform the film tube into film tracks, one uses diverse cutting devices, which supplement the winding devices and slit the tubes directly before the beginning of the winding process. For that, in general, trimming cuts are made on both edges of the flat laid film tube. However, considerable waste is produced in this process. Since modern control processes can enable exact setting of the diameter of the extruded tubular film, and thus also the width of the flat laid film tube, trimming cuts are often dispensed with. Instead, slit knives are installed on the winding devices, which slit open the flat laid film tube track directly at its edges and thus avoid unnecessary waste.

This kind of production of film tracks from tubular films is, however, not suitable for thin, sensitive or sticky films. These films are also effected by the action of the slitting knife on the flat laid tubular films. Films of the aforementioned type are therefore still produced with the help of trimming cuts.

Consequently, the task of the present invention is to suggest a device, which enables production with gentle handling of flat films from tubular films.

The task is solved by
providing at least one pre-squeeze roller in the direction of the conveyance of the film tube before the squeeze rollers (3),
which leaves behind a remainder of air in the film tube, so that a static air cushion forms in the area between at least one pre-squeeze roller and the squeeze roller,
and that the film tube can be slit with the cutting device in the area of the static air cushion.

By taking this measure, the aforesaid cutting device can slit open the film tube, intended whereby is the normal cutting, as well as the perforation of the tube, which can then be separated much later and can engage into the film tube that is not yet completely flat, without damaging the walls of the film. Thereby, the cutting of the film tube in the area of the static air cushion leads to straight cuts, which is not possible in the area of the blown films that are often fluttering, unstable and not pre-squeezed.

Here the static air cushion means the region, in which the still contained air in the film tube behaves more quietly than that in the region of the film tube lying before in the direction of conveyance of the film tube.

It is thereby advantageous to provide the pre-squeeze rollers between the lay-flat and the cutting device, so that even when the pre-squeeze roller lays the film tube almost flat, it still leaves a remainder of air in the film tube. The static air cushion which forms in this way prevents the knives of the cutting device from damaging the film tube and the film tracks.

It is of advantage, if the described pre-squeeze device consists of two squeeze rollers. In general they are at a larger distance from each other compared to that from the squeeze rollers.

Another preferred embodiment of the device for manufacturing of the film tracks consists of a reversing device which reverses the film tracks formed in the cutting process that lie flat above each other.

In the manufacture of adhesive tapes, it is particularly advantageous, if the adhesive tape layer forms the external periphery of the extruded film tube. In that way, the sticking together of two film tracks is prevented, especially during their common transportation through the reversing device.

An illustrative design of the invention is shown with the help of the figures and the description of the embodiment.

The individual figures show:

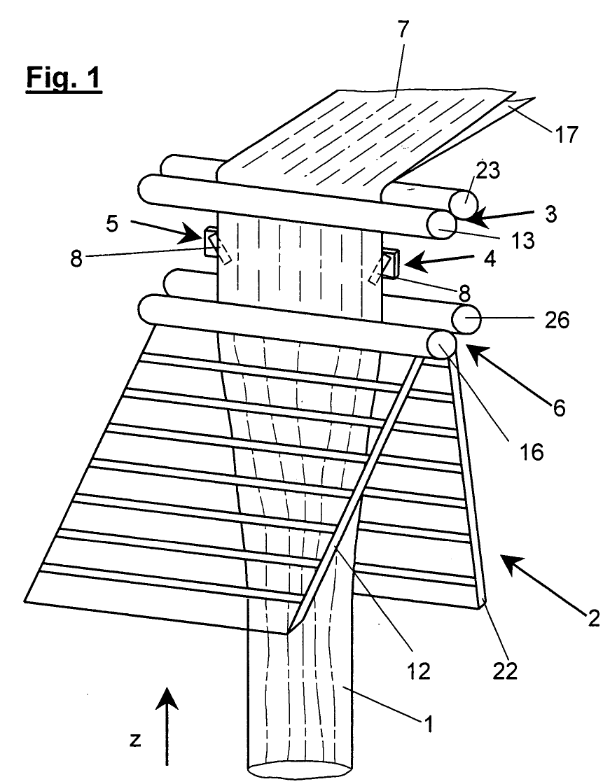

FIG. 1. A complete view of a device according to the invention

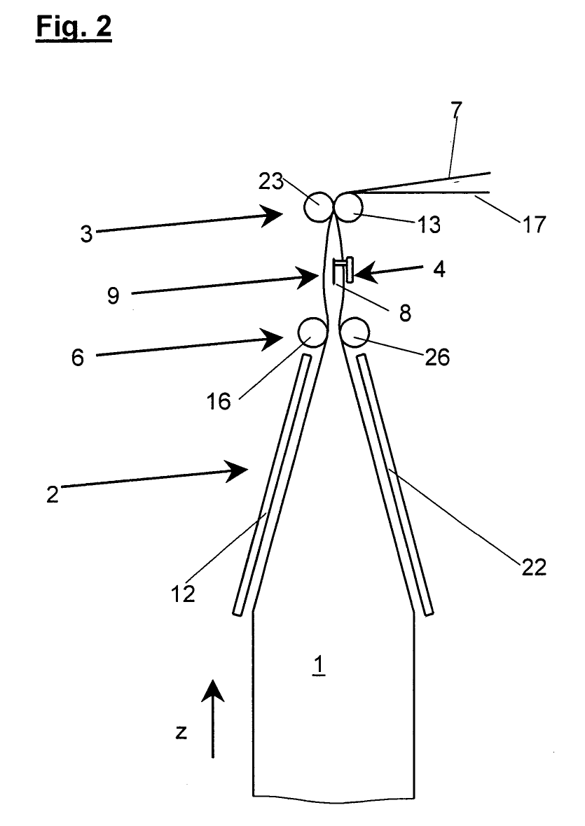

FIG. 2. A side view of the device

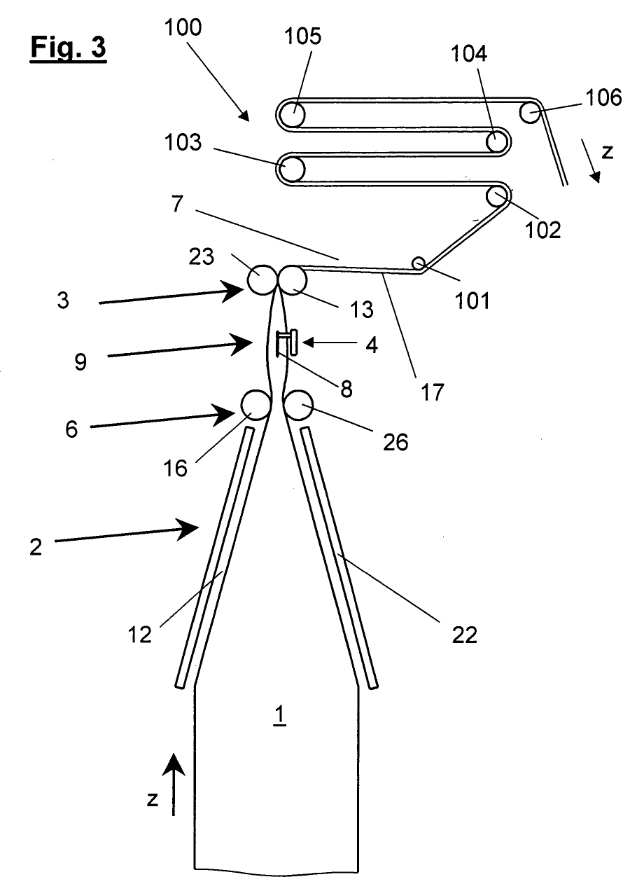

FIG. 3. A side view of a device according to the invention

FIG. 1 shows a device for manufacturing film tracks 7, 17 from a tubular film 1 according to the invention.

The film tube 1 extruded from the tubular film extrusion unit, not shown here, usually has a circular profile in the radial direction. A lay-flat device 2 is connected in the transportation direction z, which successively compresses the profile from two opposite sides. Behind the lay-flat device 2, the squeeze rollers 6 convey the film tube 1. The attendant pre-squeeze rollers 16 and 26 are at a distance from each other in such a way that the straight sides of the film tube 1 do not lie yet above each other. Since the films are still not completely squeezed, an air cushion remains in the film tube 1. Two cutting devices 4, 5 follow thereafter. Each of these cutting devices 4, 5 contains a knife 8, which is fixed on the machine frame in a manner, not shown in greater detail here. These knives 8 are arranged in such a way that they slit the film tube 1 open at its round edges. In the further course, the film tracks 7, 17 generated through the slitting pass through the squeeze device 3, which consists of two squeeze rollers 13, 23. This device serves the purpose of pressing the two film tracks 7, 17 flat on top of each other, and consequently for preventing capture of air between the two film tracks 7, 17. For the sake of elucidation, the film tracks 7, 17 are shown moving apart from each other in FIG. 1, however, they are conveyed to the reversing device, not displayed here, lying flat on top of each other. A suitable reversing device is described in greater detail, for instance, in the printed publication DE 100 40 055 A1. A common guide for the two films 7, 17, which lie above each other in a reversing device, is also technically possible in an another reversing embodiment. In that context, it is worthy of mention that there are also generic devices for manufacture of film tracks from tubular films, which manage completely without a reversing device.

The side view of the device according to the invention shown in FIG. 2 illustrates the process of the flat laying of the film tube in the lay-flat device 2, of which only the two sides of the lay-flat plates 12, 22 can be seen. One can clearly recognize that the subsequently following pre-squeeze rollers 16, 26 are at a fixed distance from each other. Depending, among other things, on the operating parameters, this distance is selected in such a way that there is yet an air cushion within the film tube at the level of the cutting device 4. Due to the air cushion, the parts of the film tube 1, which form the film tracks 7, 17 after slitting, have a somewhat larger distance from each other than while passing through the squeeze roller device. The squeeze rollers 13, 23 prevent the air from escaping through the pre-squeeze roller 3. This way the film tube can be slit laterally through contact with the knives 8 without the danger of damaging even very thin or sticky film tracks 7, 17.

In order to maintain sufficient pressure within the film tube, it can—considering the slit formed by the cutting device 4—be necessary to continuously supply air to the film tube 1.

Devices, which can supply air continuously, are known. Thus, shutting heads are often employed to supply inner cooling air to the film tube.

FIG. 3 shows once again the same device displayed in FIG. 2, whereby the reversing device 100 is also shown once again. After the film tracks 1,17 have passed through the squeeze rollers 3, they are conveyed together past the guide roller 101, the first idle roller 102, the first air turning bar 103, the second idle roller 104 and the first air turning bar 105. Finally, the film tracks 7, 17 reach a stationary roller through the delivering roller 106, which does not take part in the reversing process. Subsequently, the film tracks 7, 17 are conveyed to further processing or storage devices not displayed here. The distance between the film tracks 7, 17 from the squeeze rollers is displayed disproportionately large, in order to illustrate that there are two tracks. In general, film winders are built in first. Thereby, the film tracks can be winded up individually or together.

At this point it should be mentioned again that in FIG. 3 only the design in principle of an exemplary, very highly advanced reversing device was shown, whereby the holder of the film guiding elements 101 to 105 in the sketch, as well as the actual reversing process, which occurs due to the reversing movements of the rollers and the rods 103 to 105, around the vertical axis are not shown here. However, the method according to the invention covers all the reversing processes.

In addition to that, it should be emphasized once again, that the reversing devices, with the deviating numbers of idle rollers 102, 104 and angle bars 103, 105 are also known. In that context, reference be made once again to the printed publications, such as, for instance, DE 100 40 055, DE 43 03 952 or EP 0 873 845.

Of particular advantage are such tube reversing devices, in which a turning bar and an idle roller form a function pair. In such function pairs, the one idle roller and the one turning bar execute a reversing movement, which takes place with respect to an axis, oriented orthogonally to the rotation of the idle roller about its principal axis of symmetry. This axis is in general vertical and hence oriented in the main conveying direction of the film. Reversing devices with one, two or even three function pairs are known. The word function pair and its importance in the described reversing devices is described in the registered patent DE 100 40 055.

List of Reference Symbols

| | |
|---|---|
| 1 | Film tube |
| 2 | Lay-fIat device |
| 3 | Squeeze roller device |
| 4 | Cutting device |
| 5 | Cutting device |
| 6 | Pre-squeeze device |
| 7 | Film track |
| 8 | Knife |
| 9 | Static air cushion |
| 10 | Arrow in the direction of conveyance of the film tube |
| 11 | |
| 12 | Bypass path |
| 13 | Squeeze roller |
| 14 | |
| 15 | |
| 16 | Pre-squeeze roller |
| 17 | Foil track |
| 18 | |
| 19 | |
| 20 | |
| 21 | |
| 22 | |
| 23 | Squeeze roller |
| 24 | |
| 25 | |
| 26 | Pre-squeeze roller |
| 100-106 | Film guide elements |
| z | Direction of conveyance of the film tube |

1. Device for manufacture of film tracks (7,17) of a film tube (1)
with a lay-flat device (2), which consists preferably of two lay-flat plates (12, 22) with a mutual roof-like formation, whereby their distance decreases in the direction of conveyance (z) of the tube
and a squeeze roller device (3), which consists preferably of a squeeze roller pair (13, 23),
and at least a cutting device (4, 5), which slits the film tube along its direction of conveyance
characterized in that
in the direction of the film tube (z), before the squeeze roller device (3), at least one pre-squeeze device (6) is provided,
which leaves a remainder of air in the film tube, so that in the region between the squeeze roller device (3) and at least one pre-squeeze roller device (6), a static air cushion is formed,
and that the film tube (1) can be silt with the cutting device (4, 5) in the region of the static air cushion (9).

2. Device according to claim 1 characterized in that before the lay-flat device (2), in the direction of conveyance (z) of the film tube (1), the pre-squeeze device (6) is positioned.

3. Device according to claim 1 characterized in that the pre-squeeze device (6) consists of a pre-squeeze roller pair (16, 26)

4. Device according to claim 1 characterized in that a reversing device, which reverses the foil tracks (7,17) generated in the slitting process with the cutting devices (4, 5), while the film tracks are lying apart.

5. Device according to claim 1 characterized in that the pre-squeeze rollers (13, 21) of the pre-squeeze roller pair are arranged mutually in such a fashion that the walls of the film tube touch each other at least while passing through the pre-squeeze roller pair.

6. Device according to the above claim characterized in that a reversing device (100), in which the film tracks (7,17) can be conveyed bypassing one of the reversing air turning bar (103, 105) and at least one idle roller (102, 104).

7. Device according to claim 1 characterized in that the reversing device (100) includes at least one function pair, built out of an air turning bar (103, 105) and an idle roller (102, 104), whereby the air turning bar (103, 105) and the idle bar (102, 104) carry out a reversing motion about an axis that is orthogonal to the direction of revolution of the idle roller.

8. Method for manufacture of film tracks (7,17) from a film tube (1)
whereby the film tube is laid flat with a lay-flat device (2), which (2) consists preferably out of two lay-flat plates (12, 22) in a mutual roof-like formation, whose distance decreases in the direction of the conveyance (z) of the tube,
and one pre-squeeze device (3), which consists preferably of a pre-squeeze roller pair (13, 23), squeezes the tube
and at least one cutting device (4, 5) slits the film tube along its direction of conveyance.
characterized in that
a pre-squeeze device (6), which is provided in the direction of the conveyance of the film tube (z) before the pre-squeeze roller device (3), carries out the pre-squeezing of the film tube (1), whereby a residual amount of air forms remains in the film tube (1), so that a static air cushion forms in the region between the squeeze roller device (3) and at least one pre-squeeze roller device (6),
and that the film tube (1) is scratched in the region of the static air cushion (9) by means of the cutting device (4, 5).

9. Method according to the above claim, characterized in that at least two film tracks, which form due to the slitting through of the film tube, are guided through a reversing device after passing through the squeezing roller pair, whereby a part of the regions of the at least two film track touch each other.

10. Device according to claim 2 characterized in that a reversing device, which reverses the foil tracks (7,17) generated in the slitting process with the cutting devices (4, 5), while the film tracks are lying apart.

11. Device according to claim 3 characterized in that a reversing device, which reverses the foil tracks (7,17) generated in the slitting process with the cutting devices (4, 5), while the film tracks are lying apart.

12. Device according to claim 2 characterized in that the pre-squeeze rollers (13, 21) of the pre-squeeze roller pair are arranged mutually in such a fashion that the walls of the film tube touch each other at least while passing through the pre-squeeze roller pair.

13. Device according to claim 3 characterized in that the pre-squeeze rollers (13, 21) of the pre-squeeze roller pair are arranged mutually in such a fashion that the walls of the film tube touch each other at least while passing through the pre-squeeze roller pair.

14. Device according to claim 4 characterized in that the pre-squeeze rollers (13, 21) of the pre-squeeze roller pair are arranged mutually in such a fashion that the walls of the film tube touch each other at least while passing through the pre-squeeze roller pair.
